(19) United States
(12) Patent Application Publication
(10) Pub. No.: US 2007/0180993 A1
(43) Pub. Date: Aug. 9, 2007

(54) Chemical filter unit

(76) Inventors: Ju-Sang Byun, Hwaseong-gun (KR); Ki-Ryong Choi, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/650,433

(22) Filed: Jan. 8, 2007

(30) Foreign Application Priority Data
Feb. 6, 2006 (KR) 2006-11331

(51) Int. Cl. B01D 53/22

(52) U.S. Cl. 96/7

(57) ABSTRACT

A chemical filter unit includes a housing, a first filter for filtering liquid chemicals, a second filter for filtering air, and a window in the housing. The housing has an outlet and an inlet through which chemicals enter and leave the filter, respectively, and an air vent that allows air to be discharged from the filter. The first filter is disposed in a path along which chemicals flow inside the housing to filter out particles contained in the chemicals, and the second filter is disposed in a path along which air leaves the filter through the air vent. The second filter includes a medium that collects particles contained in the air. The window allows the second filter to be seen from outside the housing.

### BACKGROUND OF THE INVENTION

1. Field of the Invention

The present invention relates to filters. More particularly, the present invention relates to filters for removing particles from chemical solutions used in the manufacturing of semiconductor devices and the like.

2. Description of the Related Art

Semiconductor devices must be manufactured under strict process conditions, using chemicals applied according to precise manufacturing techniques, and in an environment having a high level of cleanness. With respect to the latter, wafers from which the semiconductor devices are manufactured must be isolated during the manufacturing process from contaminants that would otherwise damage or adversely affect the characteristics of the resulting semiconductor device. One of the measures taken to prevent a wafer from being contaminated is to filter the chemicals used in semiconductor device manufacturing process. That is, a high quality semiconductor device can not be manufactured without the use of clean chemicals provided by one or more filters.

Conventionally, a chemical filter unit that is disposed in-line with semiconductor device manufacturing equipment is periodically replaced, i.e., is replaced simply after it has been used for a predetermined period of time. Therefore, efforts have been made to extend the useful life of a chemical filter unit in order to reduce the time and costs associated with replacing the filter unit. However, sometimes the chemicals used in a fabrication process become contaminated before the useful life of the filter unit expires. In this case, the filter of the unit may fail to filter the chemicals sufficiently for some period of time. Thus, the devices that are being manufactured may be contaminated. On the other hand, the chemical filter unit may be replaced before its filter has ceased being effective, i.e., the chemical filter is prematurely consumed. Therefore, conventional chemical filter units can have a negative impact on production yield and manufacturing costs.

### SUMMARY OF THE INVENTION

An object of the present invention is to provide a chemical filter unit that can minimize downtime of the equipment associated with the need to replace the unit.

Another object of the present invention is to provide a chemical filter unit that can keep manufacturing costs down.

A more specific object of the present invention is to provide a chemical filter unit that allows the degree to which it is contaminated, i.e., its current state of usefulness, to be checked visually.

According to one aspect of the present invention, a chemical filter unit has a housing, a filter medium disposed in the housing and adapted to collect contaminants in the fluid being filtered by the unit, and a window in the housing and through which the filter medium can be viewed.

The housing has a main body, an inlet and an outlet for allowing chemicals to flow through the main body, and an air vent for allowing air to be discharged from the housing. A first filter is disposed within the main body of the housing in a path along which the chemicals flow to the outlet. Thus, the first filter filters out particles contained in the chemicals. A second filter is disposed within the housing to collect particles contained in air discharged from the housing through the air vent. The window faces the second filter so that the second filter can be viewed from outside the housing. The window may include includes a magnifying lens that magnifies the image of the second filter.

The first filter may include a pleated porous membrane in the form of a cylinder. The second filter may include at least two pleated porous membranes stacked one atop the other. Preferably, the second filter includes a first membrane that collects relatively small particles and a second membrane that mostly collects relatively large particles. To this end, the interstices of the second membrane are wider on average than the interstices of the first membrane, and the first membrane is disposed closer to the air vent than the second membrane.

According to still another aspect of the present invention, there is provided a chemical filter unit including a housing having a cylindrical sidewall, an inlet, an outlet and an air vent, a first filter including a pleated porous membrane in the form of a cylinder and disposed in the housing between the inlet and the outlet in such a way that the first filter will filter liquid chemicals flowing from the inlet to the outlet, a second filter disposed within the housing between the first filter and the sidewall of the housing at such a location relative to the air vent that the second filter will filter air flowing into the air vent, and a window facing the second filter so that the second filter can be seen from outside the housing. The window may include includes a magnifying lens that magnifies the image of the second filter. The second filter includes first and second pleated membranes stacked on each other. Each of the first and second pleated membranes is porous. The interstices of the second pleated membrane are wider on average than the interstices of the first pleated membrane, and the first pleated membrane is disposed closer to the air vent than the second pleated membrane.

The first filter may also include a cylindrical core surrounded by the cylindrical pleated membrane, and at least one retainer surrounding the cylindrical pleated membrane. The core has openings extending radially therethrough. The central axis of the first filter may coincide with that of the housing. Preferably, though, the central axis of the first filter is offset and parallel to central axis of the housing.

Also, one or more of the pleated porous membranes may be made of polytetrafluoroethylene (PTFE), polychlorotrifluoroethylene (PCTFE), polyvinylidene difluoride (PVDF), or polyvinyl fluoride (PVF).

According to the present invention, a membrane that can collect particles is disposed inside the housing of a chemical filter unit. Also, a window, preferably in the form of a magnifying glass, allows the membrane to be viewed from outside the housing. Therefore, the degree to which the filter unit has been contaminated can be viewed from outside the housing, i.e., while the unit is in use. Therefore, the unit can be replaced at the time its useful life has expired. Accordingly, downtime of the equipment can be minimized and manufacturing costs associated with the filtering of chemicals can be minimized.

### BRIEF DESCRIPTION OF THE DRAWINGS

These and other objects, features and advantages of the present invention will become clearer from the following detailed description of the preferred embodiments thereof with made with reference to the accompanying drawings. Note, like reference numerals designate like parts throughout the various drawings. In the drawings:

FIG. 1 is a partially cut-away perspective view of a first embodiment of a chemical filter unit according to the present invention;

FIG. 2 is a partially cut-away perspective view of a first filter of the chemical filter unit according to an embodiment of the present invention;

FIG. 3 is a perspective view of a second filter of the chemical filter unit according to the present invention;

FIG. 4 is an enlarged cross-sectional view of a portion of the second filter illustrating the filtering out of large and small particles by respective membranes of the second filter;

FIG. 5 is an explanatory diagram illustrating the collecting of dust using the second filter;

FIG. 6 is a color chart by which the state of the second filter can be ascertained;

FIG. 7 is a partially cut-away perspective view of another embodiment of a chemical filter unit according to the present invention; and

FIG. 8 is a perspective view of another type of second filter according to the present invention.

### DETAILED DESCRIPTION OF THE PREFERRED EMBODIMENTS

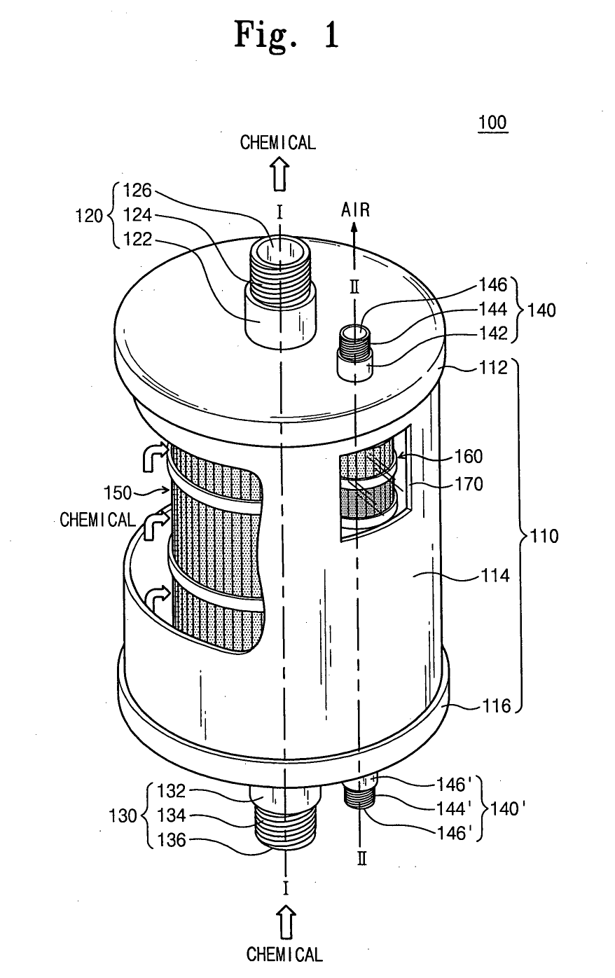

Referring to FIG. 1, an embodiment of a chemical filter unit 100 according to the present invention includes a housing 110 and a first filter 150 mounted within the housing 110. The housing 110 and the filter 150 each may be approximately cylindrical. The chemical filter unit 100 filters foreign substances or contaminants (referred to as “particles” hereinafter) from chemicals to purify the chemicals. An example of the chemicals that can be filtered by the chemical filter unit 100 is the photosensitive solution used in photolithography.

The housing 110 has a main body, and an inlet, an outlet and at least one air vent open to the interior of the main body. The first filter 150 is disposed in the main body of the housing in the path along which fluid flows from the inlet to the outlet. More specifically, the housing 110 has a cylindrical sidewall 114, and a top wall 112 and a bottom wall 116 coupled to the top and bottom of a cylindrical sidewall 114, respectively. The top wall 112 has an outlet 120 and an air vent 140. The bottom wall 116 has an inlet 130. Chemicals flow into the housing 110 through the inlet 130. The chemicals that have flowed into the housing 110 are filtered by the first filter 150. The chemicals that have been filtered by the first filter 150 in the housing 110 flow out of the main body of the housing 110 through the outlet 120.

The outlet 120 of the housing 110 is a cylindrical member 122 protruding form the top wall 112 of the housing 110. Thus, the outlet 120 defines a passageway 126 open to the interior of the main body of the housing 110. A portion of the cylindrical member 122 constitutes a connector 124 adapted to be connected to the equipment in which the filter unit 100 is used. For example, the connector 124 may be a threaded part of the cylindrical member 122. The inlet 130 can have the same configuration as that of the outlet 120. That is, the inlet 130 may be a cylindrical member 132 defining a passageway 136 therein, and a portion of the cylindrical member 132 may be threaded so as to constitute a connector 134. The inlet 130, the outlet 120, and the first filter 150 can be designed such that their central axes are aligned (coincide) with the central axis I-I of the housing 110.

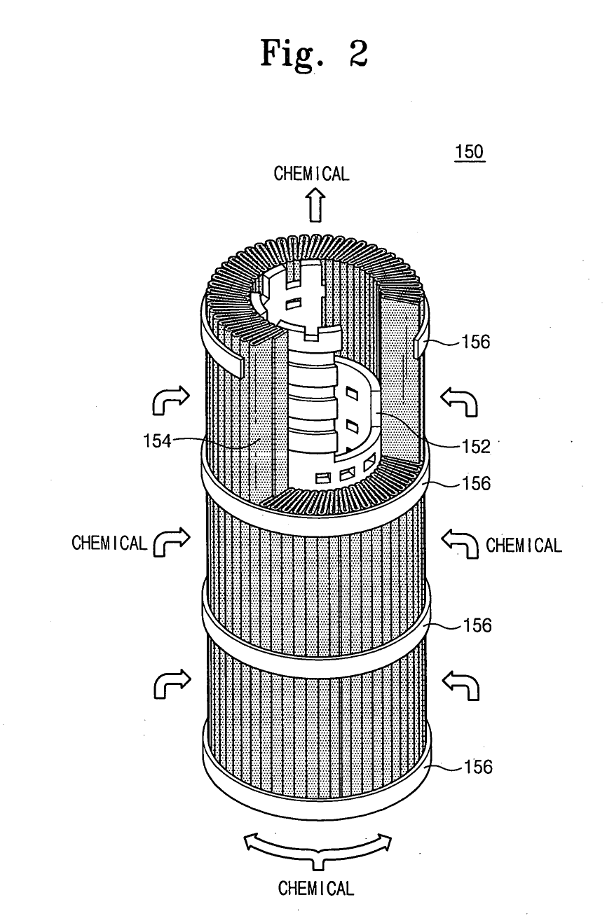

Referring to FIG. 2, the first filter 150 is interposed between the inlet 130 and the outlet 120. The filter 150 is approximately cylindrical and includes a pleated membrane 154 in the form of a cylinder, a core 152 surrounded by the pleated membrane 154, and at least one retainer 156 surrounding the membrane 154. The membrane 154 is porous, i.e., has interstices extending therethrough so as to be liquid-permeable. To this end, the membrane 154 may be formed of a fluororesin such as PTFE (polytetrafluoroethylene), PCTFE (polychlorotrifluoroethylene), PVDF (polyvinylidene difluoride), or PVF (polyvinyl fluoride). The core 152 is a cylindrical member of an essentially non-porous material but has openings extending radially therethrough. The end of the core 152 of the filter 150 closest to the inlet 130, i.e., the bottom of the core 152 is closed. For example, a lowermost one of the retainers 156 may include a circular portion that forms a cover at the bottom end of the filter 150.

The closed bottom end of the core 152 is spaced from the bottom wall 116 of the housing 110, and the top open end of the core 152 is disposed against the top wall 112 of the housing 110. Therefore, chemicals that have flowed into the housing 110 through the inlet 130 pass through the membrane 154 from the outer side thereof. Particles contained in the chemicals are filtered out by the membrane 154 while the chemicals pass through the membrane 154. The chemicals that have passed through the membrane 154 flow into the core 152, and then flow out of the chemical filter 100 through the outlet 120.

Referring again to FIG. 1, bubbles or other pockets of air that flow into the housing 110 or are generated by the filtering of chemicals within the main body of the housing 110 are discharged from the chemical filter unit 100 through the air vent 140. The air vent 140 may be a cylindrical member 142 defining a passageway 146 therein. A portion of the cylindrical member 142 constitutes a connector 144 adapted to be connected to the equipment in which the filter unit 100 is used. For example, the connector 144 may be a threaded portion of the cylindrical member 142. Of course, the structures of the outlet 120, the inlet 130 and the air vent 140 may be different from those described above.

The central axis of the air vent 140 can be offset from the central axis I-I of the housing 110. Another air vent 140′ can be provided on the bottom wall 116. Like the air vent 140 on the top wall 112, the air vent 140′ may be a cylindrical member 142′ defining a passageway 146′ therethrough. A portion of the cylindrical member 142′ is threaded so as to constitute a connector 144′. The central axis of the air vent 140′ can be located along the same axis II-II as the central axis of the air vent 140. Alternatively, the air vent 140 can be disposed to one side of the central axis I-I of the housing 110, and the air vent 140′ can be disposed to the other side of the central axis I-I, i.e., diametrically across from the air vent 140 with respect to the central axis I-I of the housing 110.

The bubbles or air pockets discharged from the chemical filter unit 100 through the air vent 140 may entrain particles (dust) removed from the chemicals by the membrane 154 of the first filter 150. A second filter 160 for collecting these particles is disposed within the housing 110. More specifically, the second filter 160 is disposed against the top wall 112 of the housing 110 over the air vent 140 in a space defined between the sidewall 114 of the housing 110 and the first filter 150. Thus, the second filter 160 is disposed in a path along which the air flows through the air vent 140.

Also, a window 170 through which an operator can check the second filter 160 by eye is disposed in the sidewall 114 of the housing 110. Thus, particles collected by the second filter 160 can be seen from the outside the housing 110 through the window 170. Preferably, the window 170 comprises a magnifying lens that provides an operator with a magnified view of the second filter 160 and the particles collected by the second filter 160.

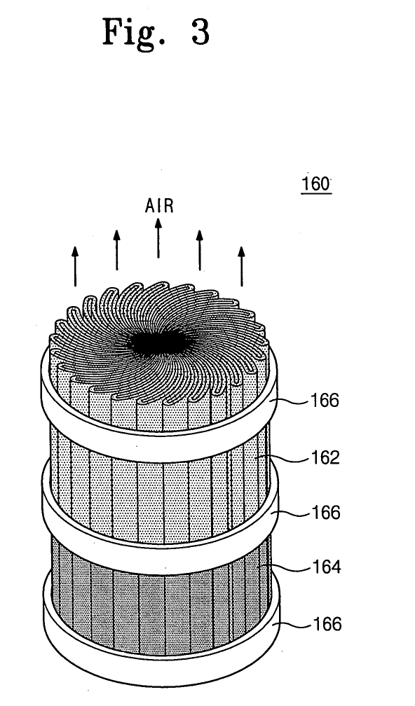

Referring to FIG. 3, the second filter 160 includes at least two stacked pleated and porous membranes 162 and 164 surrounded by at least one retainer 166 that helps the membranes 162 and 164 retain their form. The bottom end of the bottom porous membrane 164 may be covered by, for example, a (lowermost) retainer 166. As described above, the second filter 160 is interposed between the sidewall 114 of the housing 110 and the first filter 150. The second filter 160 can be cylindrical as illustrated in FIG. 3.

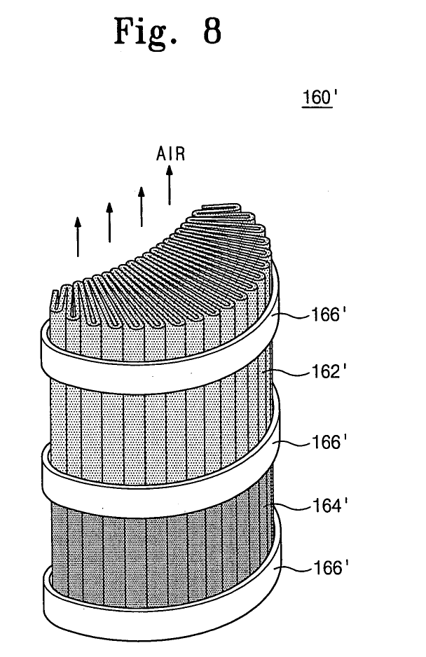

Alternatively, the second filter 160 may have an overall shape corresponding to that of the space between the sidewall 114 of the housing 110 and the first filter 150. Thus, the second filter can be crescent-shaped as illustrated in FIG. 8. In FIG. 8, reference numeral 160″ designates the second filter, reference numerals 162′ and 164′ designate pleated porous membranes, respectively, and reference numeral 166′ designates a retainer. The second filter 160 will now be described in even more detail but the same description obviously applies to the second filter 160′ and so, the second filter 160′ will not be described in more detail.

The membrane 162 closest to the air vent 140 has the same function as that of the membrane 154 of the filtering member 150, and the other membrane 164 filters out particles larger than those that are filtered out by the membrane 154. For example, assuming that the membrane 154 filters out particles having an average diameter of about 100 nm, the membrane 162 also filters out particles having an average diameter of about 100 nm, and the membrane 164 filters out particles having an average diameter greater than 100 nm. In particular, particles having a larger average diameter that is greater than 100 nm are collected by the membrane 162. Also, like the membrane 154, the membranes 162 and 164 can be formed of a fluororesin such as PTFE, PCTFE, PVDF, or PVF. In this case, the densities of the membranes 154 and 162 are substantially the same, whereas the density of the membrane 164 is less than the density of each of the membranes 154 and 162.

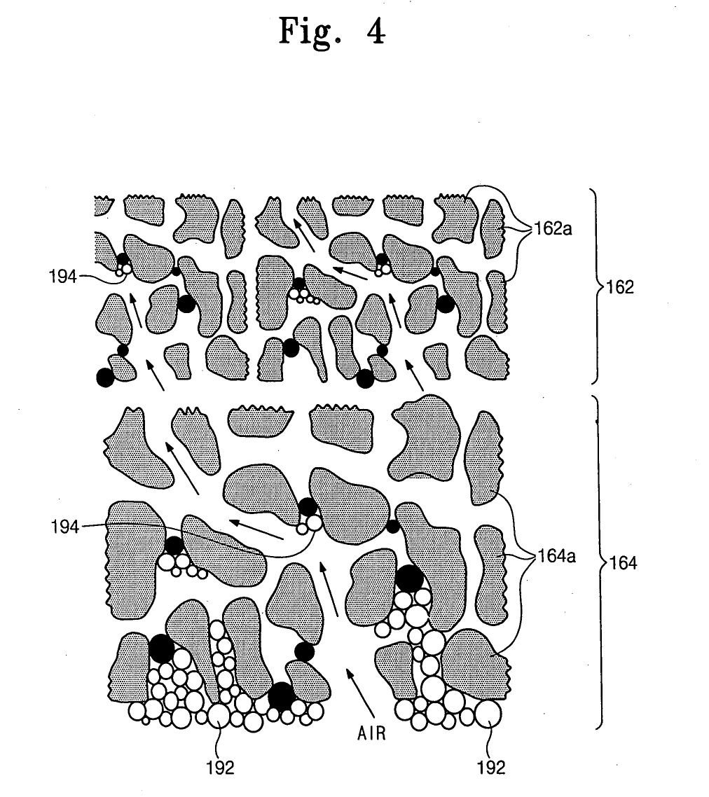

FIGS. 4 through 6 illustrate the dust-collecting function a chemical filter unit according to the present invention.

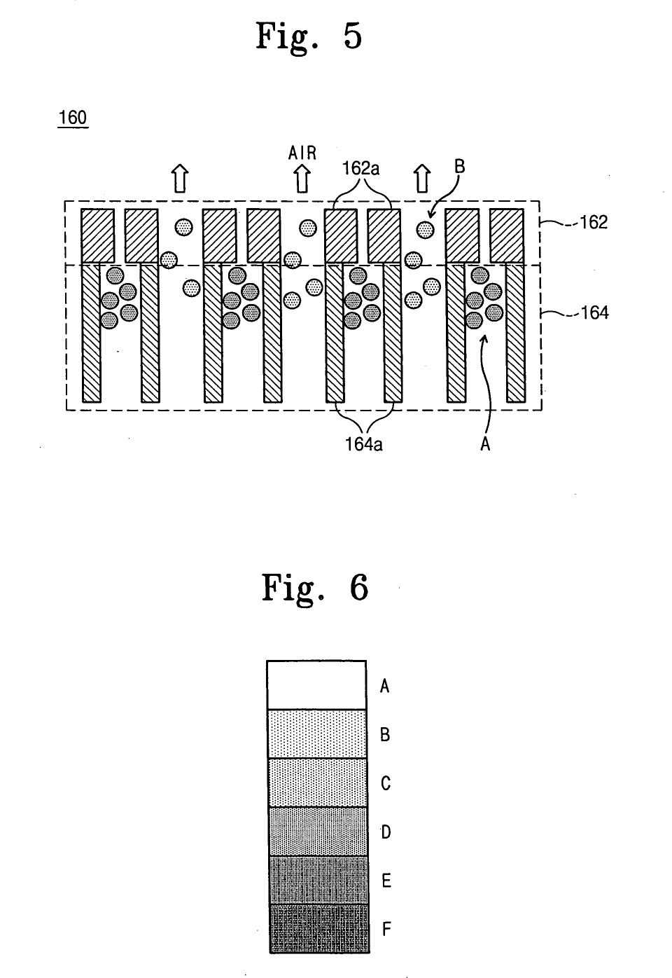

Referring to FIG. 4, large particles 192 are filtered out by numerous segments 164a of the membrane 164 when the air flows through the membrane 164 towards the air vent. In particular, the large particles 192 are trapped in the interstices of the membrane 164. Also, some small particles 194 are trapped behind the large particles 194 in the membrane 164. Therefore, large particles 192 and small particles 194 collect in the membrane 164. On the other hand, some small particles 194 pass with the air through the membrane 164 but are filtered out of the air by segments 162a of the membrane 162. Thus, small particles 192 also collect in the interstices of the membrane 162. Therefore, no large particles and very few small particles of dust pass with the air out of the second filter 160 and into the air vent, as shown schematically in FIG. 5.

In FIG. 5, reference character B designates particles that have passed through the membranes 162 and 164 with air, whereas reference character A designates particles that have been collected by the membrane 164. FIG. 6 shows various shades A-F that the membrane 164 may take on during its use. In FIG. 6, reference character A designates the shade that the membrane 164 has when no particles have collected in the membrane. The membrane 164 may take on shades B through F as particles collect in the membrane 164, i.e., the membrane 164 becomes darker as more and more particles collect in the membrane 164. Therefore, an operator can easily ascertain the state of the chemical filter unit 100 through the window 170 by checking the shade of the membrane 164 against a color chart such as that shown in FIG. 6. Thus, the chemical filter unit 100 can be replaced at an appropriate time.

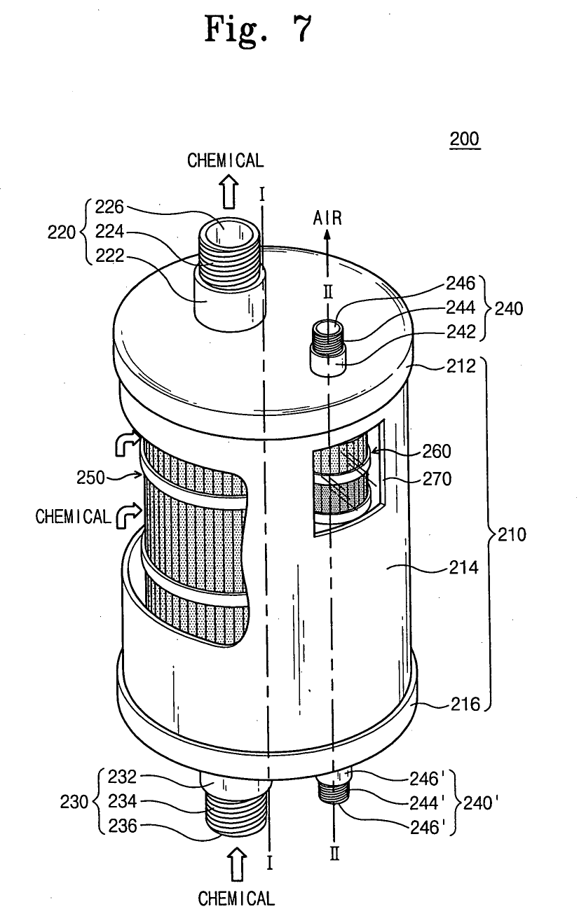

FIG. 7 illustrates another embodiment of a chemical filter unit 200 according to the present invention. The chemical filter unit 200 is similar in most respects to that the chemical filter unit 100 of the embodiment of FIG. 1. Therefore, a detailed description of some parts of the chemical filter unit 200 that are the same as those of the chemical filter unit 100 of the embodiment of FIG. 1 will be omitted.

Referring to FIG. 7, the chemical filter unit 200 includes a top wall 212, an outlet 220 and an air vent 240 protruding from the top wall 212, a cylindrical sidewall 214, a bottom wall 216, and an inlet 230 protruding from the bottom wall 216. The outlet 220 may be a cylindrical member 122 protruding form the top wall 212 of the housing 210. Thus, the outlet 120 defines a passageway 226 open to the interior of the main body of the housing 210. A portion of the cylindrical member 222 constitutes a connector 224 adapted to be connected to the equipment in which the filter unit 200 is used. For example, the connector 224 may be a threaded part of the cylindrical member 222. The inlet 230 may also be a cylindrical member 232 defining a passageway 236 therein, and a portion of the cylindrical member 232 may be threaded so as to constitute a connector 234.

The top wall 212 and the bottom wall 216 connected to respective ends of the cylindrical sidewall 214 to constitute a cylindrical housing 210. A first filter 250 is disposed inside the housing 210 between the inlet 230 and the outlet 220. Also, a second filter member 260 is disposed inside the housing 210 between the sidewall 214 and the filtering member 250. A window 270 is provided in the sidewall 214 to allow an operator to check the second filter 260 by eye.

The bubbles or air pockets discharged from the chemical filter unit 200 through the air vent 240 may entrain particles (dust) removed from the chemicals by the membrane 254 of the first filter 250. A second filter 260 for collecting these particles is disposed within the housing 210. More specifically, the second filter 260 is disposed over the air vent 240 in a space defined between the sidewall 214 of the housing 210 and the first filter 250. Thus, the second filter 260 is disposed in a path along which the air flows to the air vent 240.

The air vent 240 may be a cylindrical member 242 defining a passageway 246 therein. A portion of the cylindrical member 242 constitutes a connector 244 adapted to be connected to the equipment in which the filter unit 200 is used. For example, the connector 244 may be a threaded portion of the cylindrical member 242. Of course, the structures of the outlet 220, the inlet 230 and the air vent 240 may be different from those described above.

Another air vent 240′ can be provided on the bottom wall 216. Like the air vent 240 on the top wall 212, the air vent 240′ may be a cylindrical member 242′ defining a passageway 246′ therethrough. A portion of the cylindrical member 242′ is threaded so as to constitute a connector 244′. The central axis of the air vent 240′ can be located along the same axis II-II as the central axis of the air vent 240.

The central axes of the inlet 230, the first filter 250, and the outlet 220 are aligned along an axis that is offset from (parallel to) the central axis I-I of the housing 210. Therefore, a greater amount of space in the housing 210 is secured for accommodating the filtering member 260 in comparison with the embodiment of FIG. 1. Thus, the chemical filter unit 200 allows for a greater freedom in the design of the filtering member 260.

As described above, according to the present invention, a magnifying type of view window is provided in the housing of the filter so that a magnified image of a membrane of the chemical filter can be seen by an operator. Also, the membrane is designed to collect contaminants so that the degree to which the membrane has been contaminated can also be checked by eye. Therefore, the chemical filter unit can be replaced in a timely manner, and the yield of the devices such as semiconductor devices that are manufactured by equipment employing the chemical filter unit can be maximized.

Finally, although the present invention has been described in connection with the preferred embodiments thereof, it is to be understood that the scope of the present invention is not so limited. On the contrary, various modifications of and changes to the preferred embodiments will be apparent to those of ordinary skill in the art. Thus, changes to and modifications of the preferred embodiments are within the true spirit of the invention whose scope shall be determined by the appended claims according to the maximum extent allowed for by law.

What is claimed is:

1. A chemical filter unit comprising:
a housing having a main body, and an inlet, an outlet, and an air vent open to the interior of the main body;
a first filter disposed within the main body of the housing in a path along which chemicals introduced through the inlet flow through the main body to the outlet, whereby the first filter will filter the chemicals introduced into the housing through the inlet;
a second filter disposed within the housing at such a location relative to the air vent that the second filter will filter air flowing out of the housing through the air vent; and
a window in the housing, the window facing the second filter so that the second filter can be seen from outside the housing.

2. The chemical filter unit of claim 1, wherein the first filter comprises a pleated porous membrane in the form of a cylinder.

3. The chemical filter unit of claim 1, wherein the second filter comprises at least two stacked porous and pleated membranes.

4. The chemical filter unit of claim 3, wherein the at least two membranes of the second filter comprise a first membrane having first interstices, and a second membrane having second interstices, the second interstices being wider on average than the first interstices.

5. The chemical filter unit of claim 4, wherein the first membrane is disposed closer to the air vent than the second membrane.

6. The chemical filter unit of claim 1, wherein the window comprises a magnifying lens.

7. A chemical filter unit comprising:
a housing having an upper wall including an outlet and a first air vent, a lower wall including an inlet, and a cylindrical sidewall extending between and connected to the upper wall and the lower wall;
a first filter including a pleated membrane in the form of a cylinder, the membrane being porous such that the membrane has interstices extending therethrough, and the first filter being disposed within the housing between the inlet and the outlet thereof in such a way that the first filter will filter liquid chemicals flowing from the inlet to the outlet of the housing;
a second filter disposed within the housing between the first filter and the sidewall of the housing at such a location relative to the air vent that the second filter will filter air flowing into the air vent, the second filter including first and second pleated membranes stacked on each other, each of the first and second pleated membranes of the second filter being porous so as to have interstices extending therethrough, the interstices of the second pleated membrane being wider on average than the interstices of the first pleated membrane, and the first pleated membrane being disposed closer to the air vent than the second pleated membrane; and
a window in the sidewall of the housing, the window facing the second filter so that the second filter can be viewed from outside the housing.

8. The chemical filter unit of claim 7, wherein the first filter further includes a cylindrical core surrounded by the cylindrical pleated membrane, the core having openings extending radially therethrough, and at least one retainer surrounding the cylindrical pleated membrane.

9. The chemical filter unit of claim 7, wherein the central axis of the first filter is offset from and parallel to the central axis of the housing.

10. The chemical filter unit of claim 7, wherein the interstices of the pleated membrane of the first filter and the first pleated membrane of the second filter have substantially the same size on average, and the interstices of the second pleated membrane of the second filter are wider on average than the interstices of the first pleated membrane.

11. The chemical filter unit of claim 7, wherein at least one of the membranes comprises a material selected from the group consisting of PTFE (polytetrafluoroethylene), PCTFE (polychlorotrifluoroethylene), PVDF (polyvinylidene difluoride), and PVF (polyvinyl fluoride).

12. The chemical filter unit of claim 7, wherein the window comprises a magnifying lens.

13. The chemical filter unit of claim 7, wherein the lower wall of the housing has an air vent.
